(19) United States
(12) Patent Application Publication
(10) Pub. No.: US 2002/0117121 A1
(43) Pub. Date: Aug. 29, 2002

(54) Silk pet collar

(76) Inventor: Joseph Sporn, New York, NY (US)

Correspondence Address: Hopgood, Calimafde, Judlowe & Mondolino, 60 East 42nd Street, New York, NY, 10165, US

(21) Appl. No.: 09/795,845

(22) Filed: Feb. 28, 2001

(51) Int. Cl. A01K 27/00

(52) U.S. Cl. 119/856

(57) ABSTRACT

A pet collar having reduced friction with an outer satin covering of a dense weave, and an inner polymeric liner. Alternatively, a satin sleeve having openings for access to the functional aspects of a collar is provided for use with a conventional collar. The low friction fabric covering reduces matting of hair and irritation to the pet's skin.

### BACKGROUND OF THE INVENTION

1. Field of the Invention

This invention relates to a structure for a pet collar that is less irritating and less prone to hair matting than conventional collars; namely, a collar having a soft and pliable interior and an exterior that is made of a dense weave of a satiny material.

2. The State of the Art

Pet collars, whether for dogs, cats, ferrets, iguanas, or whatever mammalian or reptilian pet, are typically made of leather, or of a synthetic fiber such as nylon, polypropylene, or the like, or a blend thereof. The collar is sewn in a conventional pattern; typically there is a single or double layer having a seam on each edge. A leather collar is typically made from a single or double layer of leather having a seam just in from each of the edges. For a nylon collar, a single, thick layer of fabric can be used without any sewing.

Pets often have problems with irritation and abrasion caused by conventional collars rubbing on their coat or skin. The most typical problem is caused by friction the collar creates by rubbing along the pet's neck. This friction can cause the hair to wear away, and then the pet's skin is exposed to the collar, which exacerbates the irritation by abrading the skin. For some pets, especially those with long hair, the friction can cause matting of the hair just under the collar, which is also uncomfortable for the pet. Nylon collars are typically made in a coarse weave, allowing hair to pass through the spaces of the weave, resulting in the pet's hairs either being pulled out or matting. Matting of hair is not only uncomfortable for the dog, it is a leading cause of skin irritations (hot spots are often found under matted hair), and makes grooming (for both the dog, its owner, and pet groomers) much more difficult.

In light of the foregoing, it is an object of this invention to provide a collar that is durable and yet comfortable to a pet, avoids matting of the pet's hair, and has a low coefficient of friction to avoid matting and loss of hair under the collar, which is relatively durable compared with existing collars, and which is cost effective to make and to buy.

### SUMMARY OF THE INVENTION

This invention provides a pet collar having on its exterior a sleeve of a satiny material, preferably silk, synthetic satin, or a blend thereof, sewn onto a durable liner, preferably a polymeric liner, and most preferably made from PVC or PU (that is, poly(vinyl chloride) or polyurethane). The collar is fabricated to appear similar in construction to a conventional leather collar. The silk, satin, or similar low friction fabric avoids abrading the pet's skin, avoids matting the pet's hair or fur, is relatively durable, and the tight weave prevents hairs from getting pulled out. The liner is a durable, pliable, and preferably supple polymeric band of the usual dimensions for collars.

### BRIEF DESCRIPTION OF THE DRAWING

FIG. 1 depicts a partial cross sectional view of the instant collar.

FIG. 2 depicts a top view of a sleeve adapted to accept a conventional collar.

### DESCRIPTION OF SPECIFIC EMBODIMENTS

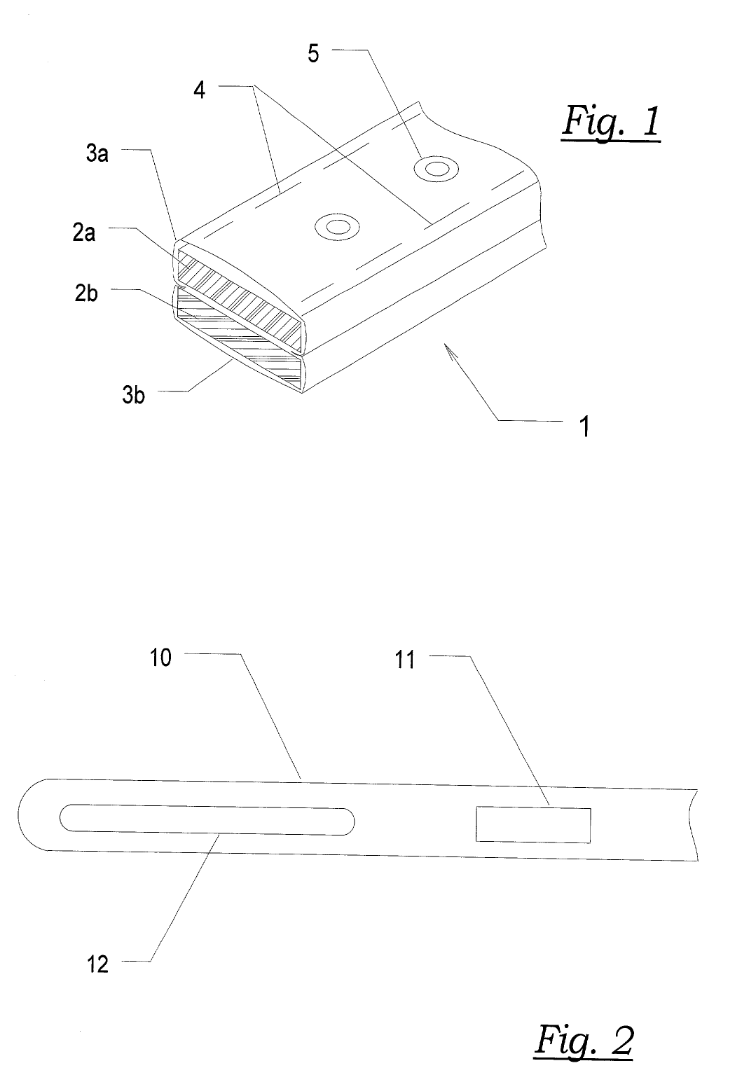

FIG. 1 depicts a partial cross sectional view of the collar 1 of this invention. Although the construction need not be identical with that shown and described herein, it is preferable that the collar simulates a conventional collar in its construction and operation. The preferred construction includes two liners 2a, 2b, around the outer face of each is wrapped a low friction fabric 3a, 3b effective to cover the outer face, and the two wrapped liners are sewn together with one or more fibers 4. Although a single liner can be suitable for a smaller animal, pliable plastics are typically not as tough as leather, and so for larger animals dual liners are preferred. The low friction fabric is shown in the figure is shown attached more loosely than would typically be manufactured. The other accouterments of a collar, such as the grommets 5 at the end used for adjusting the size of the collar, and the buckle and tongue combination, are well known to those of ordinary skill in this art. The liners effectively back the fabric covering, although it may be desirable to include a second lining or padding between the main liner (2a and/or 2b) and the fabric covering.

The satiny fabric preferably is China silk, glove silk, Habutai, Organza, Pongee, Rajah brand, satin, or similar satin-type fabric made from silk, rayon, or a blend having a major portion of silk, rayon, or a low friction synthetic, or a combination thereof. The fabric preferably has a plain, dense weave, the smoother the better to avoid entangling hairs. A “satin” is typically defined as a silk or rayon (acetate or viscose) fabric with a smooth lustrous surface devoid of pattern. Any fabric having the attributes of satin and a majority of the toughness and durability of silk will be suitable.

Pet allergies are often very different from human allergies. For example, mercaptobenzathiazole and related compounds are used in making synthetic foams and various rubber gloves, and a small percentage of the human population are allergic to this compound (the allergy may be mistaken first as latex allergy). On the other hand, the same compound is sold under the brand name Sulfodene to ameliorate the symptoms of “hot spots” on dogs' coats which may be caused by contact dermatitis or food allergies. Accordingly, the fabric and the liner should be devoid of allergens to the extent possible, including assuring that dyes and finishes used for the fabric are hypoallergenic to the pet for which the collar is designed.

The liner is preferably made from a highly plasticized PVC (poly(vinyl chloride)) or PU (polyurethane). The liner should have the physical properties of artificial leather, which is a well-known item made from PVC or PU. Various suppliers of artificial leather include Yang Hsin Mach. Co., Ltd. (Taipei, Taiwan; http://www.allproducts.com/machine/yanghsin), C&S Industrial Co., Ltd. (Seoul, Korea; http://www.usedlist.com), Industrial Fashion (China), Ltd. (Jiaxing, China; http://www.fabric.com.cn). The liner need not have any of the surface texture or coloring of artificial leather because it is not seen, and because the surface texture appearing through the covering can increase the friction of the collar. In essence, the liner need be sufficiently pliable to easily wrap around the pet's neck, and sufficiently tough to withstand the pet tugging on the leash.

The liner and fabric are secured preferably by being stitched together using any suitable material, including silk, satin, cotton, nylon, blends thereof, and the like, so long as the material is sufficiently tough to hold the liners together (if there is more than one) and to hold the covering to the liner. If desired, depending on the composition of the liner, an intermediate liner or padding can be disposed between the liner and the fabric cover. Although not preferred, the satiny cover can be fused to an interliner, such as is used for dress suits and coats, to form a unitary structure before being sewn to the polymeric liner. In a less preferred embodiment, although still within the scope of this invention, the satiny fabric can be fused to an interliner which is then fused or adhered with the liner.

While the preferred embodiment is a collar integral with the satin covering, another embodiment is a satin sleeve adapted to receive a conventional collar. Such a sleeve should be made of the same type of satiny material, should have openings effective to allow the metal loop on which the leash is connected to poke through the sleeve, and have holes or other openings to allow the tongue in the buckle or clasp to engage the holes, such as shown in FIG. 1, in the corresponding portion of the collar to adjust its wearing length. Preferably, the sleeve is like a sock, the closed end corresponding to the end with the eyelets. For added strength, the sleeve can be made of a satin cover material fused to an interliner.

For example, a sleeve 10 shown in FIG. 2 has an opening 11 for the metal loop and a single opening 12 allowing the holes or grommets in a conventional collar to be seen. As a sock configuration, the end 14 is sewn closed while the other end 16 is open.

The foregoing description is meant to be illustrative and not limiting. Various changes, modifications, and additions may become apparent to the skilled artisan upon a perusal of this specification, and such are meant to be within the scope and spirit of the invention as defined by the claims.

What is claimed is:

1. A collar for a pet, the improvement comprising: a liner comprising a pliable and tough polymeric material and a covering comprising a satiny fabric; said liner and said fabric being secured together.

2. The collar of claim 1, wherein the polymeric material is poly(vinyl chloride) or polyurethane.

3. The collar of claim 1, wherein the covering is silk.

4. The collar of claim 1, wherein the covering is a synthetic fiber.

5. The collar of claim 1, wherein the covering comprises both silk and a synthetic fiber.

6. The collar of claim 1, wherein the collar comprises two liners, each having an outer surface over which the satiny fabric is secured.

7. The collar of claim 1, wherein the fabric is secured to the liner by sewing.

8. The collar of claim 1, wherein the fabric is fused to an interlayer which is secured to the liner.

9. A sleeve adapted for accepting a conventional collar having a loop for engaging a leash, a buckle with a tongue, and holes through which the tongue is placed and secured by the buckle, comprising: a sleeve of satin having an opening for said loop and at least one opening for exposing said holes.

10. The sleeve of claim 9, comprising multiple openings for exposing said holes.

11. The sleeve of claim 9, wherein the satin is fused to an interliner.
